(19) United States
(12) Patent Application Publication
(10) Pub. No.: US 2009/0192904 A1
(43) Pub. Date: Jul. 30, 2009

(54) System and Method for Conducting Transactions with a Financial Presentation Device Linked to Multiple Accounts

(76) Inventors: Barbara Patterson, South San Francisco, CA (US); Kelly Alpert, Sausalito, CA (US); Jennifer Schulz, San Monica, CA (US); Stacy Pourfallah, Oakland, CA (US)

Correspondence Address: AFS/ VISA, 666 THIRD AVENUE , 10TH FLOOR, NEW YORK, NY, 10017, US

(21) Appl. No.: 12/358,790

(22) Filed: Jan. 23, 2009

Related U.S. Application Data
(60) Provisional application No. 61/023,416, filed on Jan. 24, 2008.

(51) Int. Cl. G06Q 20/00; G06Q 40/00; G06Q 30/00

(52) U.S. Cl. 705/17; 705/21

(57) ABSTRACT

System for conducting a financial transaction with a single financial presentation device linked to multiple financial accounts stores financial account information of multiple financial accounts associated with the presentation device, and a set of predetermined rules for determining which of the financial accounts is to be used to conduct a financial transaction. A linked-account processing program receives an authorization request for the financial transaction which has been initiated at a merchant's computer using the presentation device. The program determines whether the presentation device is associated with multiple financial accounts, and if so, selects one account among the multiple linked financial accounts based on the predetermined set of rules, and routes the authorization request to an issuer of the selected financial account.

### CROSS REFERENCE TO RELATED APPLICATION

This application claims the benefit of priority under 35 U.S.C. Section 119(e) to U.S. Provisional Application Ser. No. 61/023,416, filed Jan. 24, 2008, which is incorporated herein by reference.

### FIELD OF THE INVENTION

The present invention relates to financial transaction processing systems, and more specifically a system for conducting financial transactions using financial presentation devices, such as credit cards, debit cards and other financial accounts associated with a holder of such devices.

### BACKGROUND OF THE INVENTION

A financial presentation device is a device that can be presented to sellers of goods or services for payment, and includes, but are not limited to, credit cards, debit cards, prepaid cards, electronic benefit cards, charge cards, virtual cards, smart cards, key chain devices, personal digital assistants, cell phones, stored value devices and the like. Many consumers carry multiple financial presentation devices, such as one or more credit cards, debit cards and/or other financial presentation devices, to purchases goods and/or services from a merchant. Each of these financial presentation devices is typically associated with a separate account from a different issuer, although a single issuer can issue different financial presentation devices with different account numbers to a single cardholder.

When the consumer decides to purchases the goods and/or services from the merchant or other point of sale by using one of the financial presentation devices, the consumer's choice for selecting the appropriate financial presentation device is typically based on some self-determined criteria that is deemed appropriate at the time of the purchase transaction. For example, the consumer can decide to use a particular credit card or other financial presentation device to earn prize redemption points, earn cash back allowances, earn frequent flyer miles, purchase and track business related expenses, make purchases over the Internet, and/or other criteria that is important to the consumer.

As such, the consumer normally carries with his or her person multiple financial presentation devices. The consumer must then timely remember the criteria for selecting the appropriate financial presentation device card during a purchase transaction. Failure to remember the self-imposed determinants can lead to financial inconveniences or missed opportunities, such as improper tracking and/or reimbursement of business expenses, loss of redemption points or cash-back allowances over a given period, and the like. Further, carrying numerous financial presentation devices (e.g., credit and debit cards) at one time can be cumbersome, as well as increase the susceptibility of the cards becoming misplaced, lost or stolen.

Therefore, it is desirable to provide a system and method for enabling a consumer to access multiple accounts from a single financial presentation device while conducting purchase transactions of goods and/or services from a merchant or other point of sale.

### SUMMARY OF THE DISCLOSURE

According to one aspect of the present invention, a method is provided for accessing multiple accounts from a single card product, or device (e.g., linkage of a Bank of America-issued debit product to a Chase-issued credit product), thereby enabling the cardholder to access either account from a single card or account representation when making a purchase. For example, some co-brand, merchant issuers may benefit from having the ability to enable their credit cardholders to link access to healthcare-related accounts (e.g., FSA, HSA) to the co-brand credit card. This would enable the cardholder to carry a single representation of account (e.g., a piece of plastic or just a number sequence or phone number) to access any registered account.

In one aspect of the present invention, a system for conducting a financial transaction with a financial presentation device of a holder which is presentable to providers of goods or services includes a memory for storing financial account information of multiple financial accounts and a set of predetermined rules for determining which of the financial accounts is to be used to conduct a financial transaction. The system further includes a processor coupled to the memory, and a linked account processing module stored in the memory and executable by the processor.

The linked account processing module is further operable to receive an authorization request for the financial transaction. The authorization request is initiated at a point of sale in response to presentation of the financial presentation device at the point of sale. The processing module is also operable to determine whether the financial presentation device is associated with multiple financial accounts. If so, then the processing module selects one account among the multiple financial accounts based on the predetermined set of rules, and routes the financial transaction request to an issuer of the selected financial account.

In another aspect of the present invention, a method is provided for conducting a financial transaction with a financial presentation device of a holder which is presentable to providers of goods or services. The method includes receiving an authorization request for a financial transaction. The authorization request is initiated at a point of sale in response to presentation of the financial presentation device at the point of sale. The method further includes determining whether the financial presentation device is associated with multiple financial accounts. If so, then one account among the plurality of financial accounts is selected based on the predetermined set of rules, and the financial transaction request is routed to an issuer of the selected financial account.

### BRIEF DESCRIPTION OF THE DRAWINGS

FIG. 1 is a block diagram of an exemplary system for linking a financial presentation device to multiple accounts;

FIG. 2 illustrates a block diagram of a computer device suitable for linking a financial presentation device to multiple accounts in the system of FIG. 1;

FIG. 3 is a flow diagram of a method for linking a financial presentation device to multiple accounts for conducting a financial transaction in accordance with the present invention;

FIG. 4 is a flow diagram of a method for registering the financial presentation device to the multiple accounts in accordance with the method of FIG. 3;

FIG. 5 is a flow diagram of a method for routing an authorization request while conducting the financial transaction from a point-of-sale (POS) to an issuer in accordance with the method of FIG. 3;

FIG. 6 is a flow diagram of a method for routing an authorization response message from the issuer to the POS in accordance with the method of FIG. 3; and

FIG. 7 is a flow diagram of a method for clearing the financial transaction in a dual-message system in accordance with the method of FIG. 3.

To facilitate understanding of the invention, identical reference numerals have been used, when appropriate, to designate the same or similar elements that are common to the figures.

### DETAILED DESCRIPTION OF THE INVENTION

For purposes of illustration and clarity, the present invention is discussed in the context of a consumer using a financial presentation device or other account access device for conducting purchase transactions with a merchant. The financial presentation device provides access to at least one financial account associated with the consumer.

The financial presentation device can be a credit card. However, persons of ordinary skill in the art will appreciate that the novel features disclosed herein apply to all types of portable financial presentation devices including, but not limited to, debit cards, prepaid cards, electronic benefit cards, charge cards, smart cards, virtual cards, key chain devices, personal digital assistants, cellular telephones, stored value devices or other account access devices such as email addresses and telephone numbers, so long as the presentation device can be presented to a seller of goods or services as a form of payment.

Although the present invention is often described in terms of a cardholder using an financial presentation device or other account access device to conduct a financial transaction, a person of ordinary skill in the art will appreciate that a cardholder includes any consumer, customer or other person possessing a financial presentation device or other access device having an associated financial account (e.g., account number) that can be used to conduct a financial transaction at a point of sale (e.g., merchant).

The present invention enables a cardholder to voluntarily link multiple card accounts to a single account, such as a credit card account or a virtual account. Advantageously, a cardholder is able to carry just a single access device such as a plastic credit card, debit card, cell phone, and the like to access multiple linked accounts to conduct a financial transaction with a merchant or other point of sale.

The cardholder voluntarily registers one of his or her accounts as a primary account for linkages with one or more secondary accounts. The registration process for the cardholder can be facilitated at, for example, the website of the primary account issuer or the website of a financial transaction processor facilitator (e.g., VISA website). Linkages are created by providing an account number, which can be the physical card account number or a virtual account number. For example, a first credit card registered as a primary account can be linked to one or more secondary accounts, such as a checking account, a flexible spending account (FSA) and/or a health savings account (HSA).

As part of the linking process, each cardholder establishes rules for when each account should be used during a financial transaction for goods and/or services. For example, the cardholder can establish rules to access and use a secondary account for all purchases made at drugstores and/or supermarkets, while using the primary account for purchases with all other merchants. In one embodiment, the cardholder can also be prompted at a POS (point of sale) device to select from a list of available accounts at the time of a purchase. For example, after the primary card has been “read” (e.g., via swipe or contactless chip) by the device, the device will prompt the cardholder with a selection menu, thereby allowing the cardholder to select the appropriate account at the time of purchase. An automatic teller machine (ATM) device or other non-merchant POS transaction device can also be used to enable account selections via a pre-established numerical representation or account naming convention.

In one embodiment, a cardholder using a primary account at an ATM can be prompted at the terminal to select one of the linked secondary accounts. For example, the cardholder using his primary credit card could enter a keypad number (e.g., #2), which illustratively corresponds to a linked account (e.g., a linked debit account). Alternatively, the terminal can prompt the consumer to select from a list of choices, such as “Healthcare” to conduct the transaction.

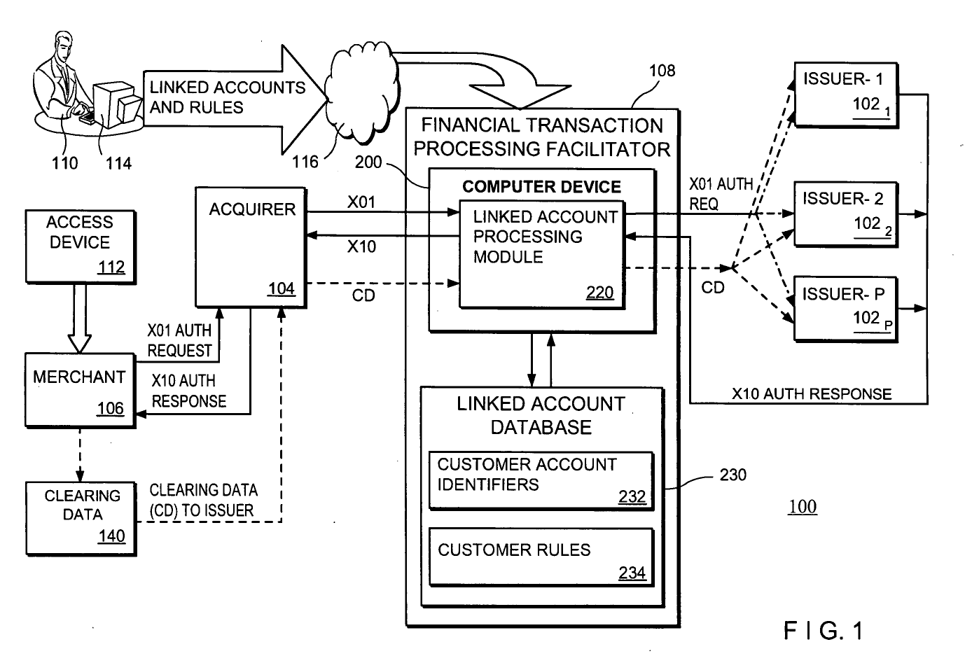

Referring now to FIG. 1, an exemplary block diagram of the above-described financial presentation device transaction system 100 is shown. The financial presentation device transaction system 100 includes at least one issuer bank 102₁ through 102ₚ, at least one acquirer bank 104, at least one merchant 106, and a financial transaction processing facilitator 108. Each issuer 102 is a financial institution (e.g., bank) or other organization that issues the access devices, such as mobile financial presentation devices (e.g., credit/debit card) 112 to the cardholders 110.

Although the present invention is described in terms of a merchant 106, a person of ordinary skill in the art will appreciate that the financial transaction can be conducted at other points-of-sales (POS) (e.g., the Internet) that allow a cardholder 110 to purchase goods and/or services by presenting a financial presentation device or other account access device 112. Further, the present invention contemplates other point-of-sale devices that permit the cardholder 110 to conduct financial transactions which are not associated with the purchase of goods and/or services, such as an automatic teller machine (ATM), cellular telephone, and the like.

For purposes of understanding the invention, each acquirer 104 is a financial institution (e.g., bank) or other organization that provides card processing services to the merchant 106. Additionally, the processing facilitator 108 is defined as a financial entity such as VISA® (among others) which operates a network that serves as an intermediary between the acquirer 104 and issuer 106 for facilitating authorization, clearing, funding and otherwise processing of transactions. More specifically, the processing facilitator 108 is a system that manages the processing, clearing and settlement of financial presentation device (e.g., credit/debit card) transactions, including the assessment, and collection and/or distribution of fees between parties.

From the perspective of the merchants 106, a credit/debit card transaction is often more secure than other forms of payment, such as checks, because the issuing bank commits to pay the merchant the moment the transaction is authorized, regardless of whether the consumer defaults on their credit card payment, excluding legitimate disputes, which can result in charge backs to the merchant. For each purchase, the bank charges a commission (discount fee) to the merchant for this service.

When the cardholder 110 pays for the purchase of goods or services using the access device 112, the merchant 106 performs some risk assessment and may submit the transaction to the acquirer 104 for authorization. The acquirer 104 verifies with the issuer 102, almost instantly, that the card number (with expiration date) and transaction amount are both valid, and informs the merchant 106 how to proceed (i.e., accept or decline the transaction). The issuer 102 may provisionally debit the funds from the cardholder's credit account at this stage.

A sales transaction between a cardholder 110 and a merchant 106 can be made with the card present at the merchant's physical location for inspection and processing, for example, through a magnetic strip card reading terminal or by key entry. The cardholder 110 indicates his/her consent to pay, by signing a receipt with a record of the card details and indicating the amount to be paid or by entering a personal identification number (PIN). When a cardholder 110 purchases an item, the cardholder 110 agrees to pay the card issuer 102, which in turn pays the merchant 106 via the acquirer 104. Transfer of payments and charge-backs between the issuer 102 and acquirer 104 are facilitated by the processing facilitator 108.

Alternatively, many merchants 106 authorize point-of-sale transaction via telephone, mail, and/or through the Internet 116. These types of transactions in which the financial presentation device 112 is not physically present for the merchants to directly process are known as card-not-present (CNP) transactions.

Referring again to FIG. 1, a financial transaction account linking system 100 allows a cardholder 110 to conduct a financial transaction using a designated access device 112 that is linked to multiple financial accounts. The financial accounts are linked to the access device 112 in accordance with predetermined rules established by the holder 110, the merchant and/or the issuer of the access device 112.

In particular, and the financial transaction processing facilitator 108 includes a computer device 200 having a linked account processing module 220 for routing transaction authorization requests from the merchant 106 or other point of sale (POS) to the appropriate (i.e., selected) issuer 102 based on the predetermined rules provided by the customer. The processing module 220 of the present invention accesses a linked account database 230, which includes customer account identifiers 232 and customer rules 234.

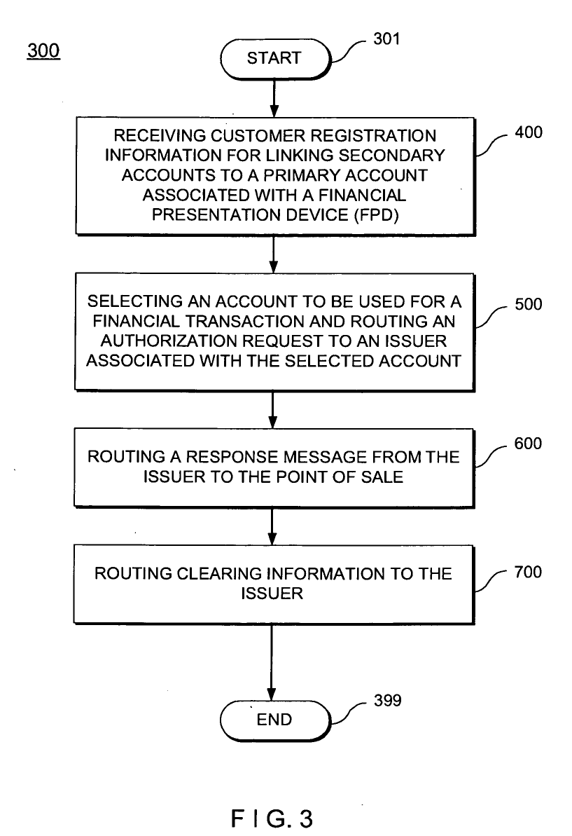

As will be discussed in greater detail below with respect to FIGS. 3-7, the linked account processing module 220 further routes the authorization response messages from the selected issuer 102 back to the merchant 106 to authorize or decline the financial transaction. The issuer 102 performs verification and authorization of the card information received for each transaction from the merchants 106. The issuer 102 sends an authorization response message that either accepts or declines the transaction back to the merchant 106 via the reverse path through the processing facilitator 108, acquirer 104, and finally to the merchant 106.

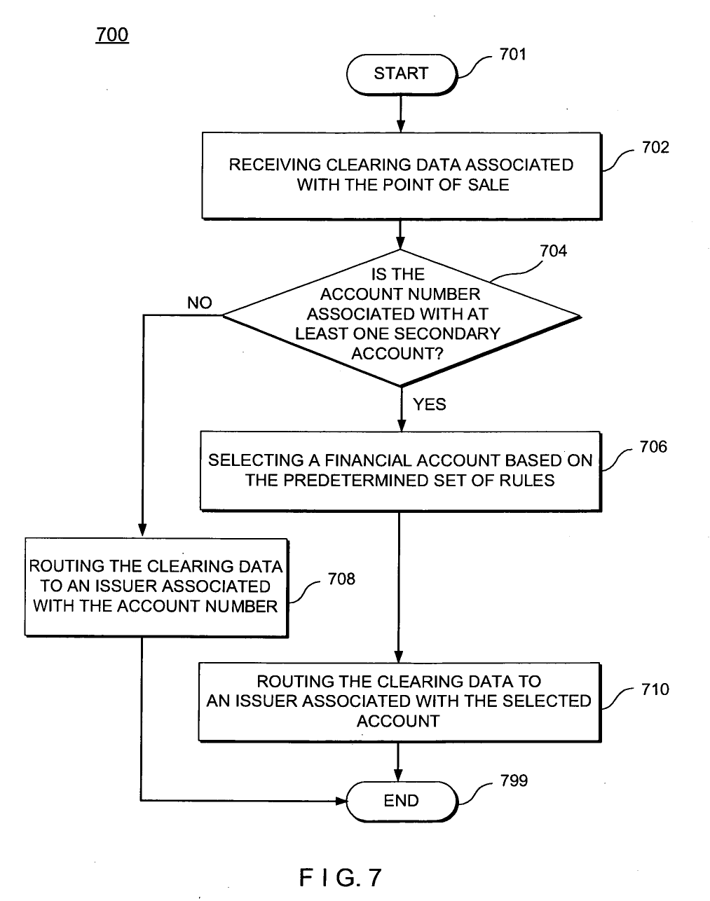

Further, where transaction clearing is provided by using dual-message processing, the clearing data 140 sent by the merchant 106 is processed by the linked account processing module 220 and then routed to the selected issuer 102 for clearing and subsequent settlement of the financial transaction. The transaction clearing processing in accordance with the present invention is described below in further detail with respect to method 700 of FIG. 7.

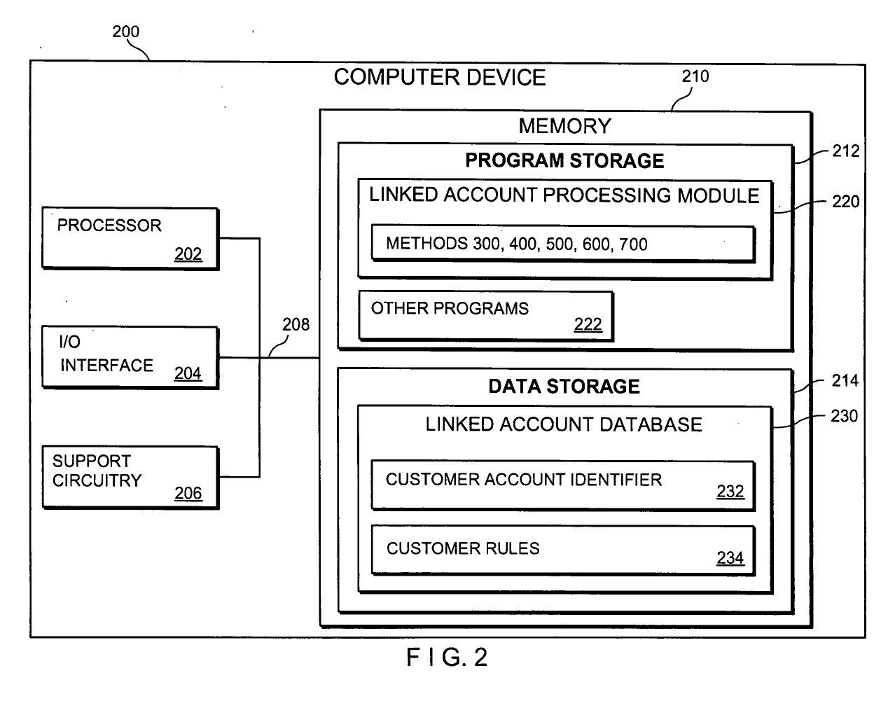

Referring now to FIG. 2, the computer device 200 can be one or more servers that centrally manage the receipt of financial presentation device information from the issuers 102 and execute programs to perform database searches to query for linked accounts associated with the financial presentation device. The computer device 200 includes a multitasking, real-time software technology that can concurrently handle hundreds of thousands of queries and updates.

The computer device 200 can be any computer device such as a personal computer, minicomputer, workstation or mainframe, or a combination thereof. While the computer device 200 is shown for illustration purposes as a single computer unit, the system may comprise a group/farm of computers which can be scaled depending on the processing load and database size.

Specifically, the computer device 200 comprises at least one processor 202, as well as memory 210 for storing various control programs 212. The processor 202 may be any conventional processor, such as one or more INTEL® Processors. The memory 210 can comprise volatile memory (e.g., DRAM), non-volatile memory (e.g., disk drives) and/or a combination thereof. The processor 202 cooperates with support circuitry 206, such as power supplies, clock circuits, cache memory, among other conventional support circuitry, to assist in executing software routines (e.g., method 300) stored in the memory 210. The one or more processors 202, memory 210 and support circuitry 206 are all commonly connected to each other through one or more bus and/or communication mediums (e.g., cabling) 208.

The computer device 200 also comprises input/output (I/O) circuitry 204 that forms an interface between various functional elements communicating with the computer device 200. For example, the computer device 200 is connected to a communication link through an I/O interface 204, which receives information from and sends information over the communication link to various card issuers 102.

The memory 210 includes program storage 212 and data storage 214. The program storage 212 stores the linked account processing module 220 of the present invention, an operating system (not shown), such as a WINDOWS® or MVS (Multiple Virtual Storage) operating system, among other application programs and data retrieval modules 222. The data storage 214 can be an internal or separate storage device, such as one or more disk drive arrays that can be accessed via the I/O interface 204 to read/write data. The data storage 214 includes a linked account database 230 which includes customer account identifiers 232, as well as the corresponding customer rules 234, both of which are generated by the customers during the enrollment process in accordance with the present invention, among other information. The linked account database 230 can be provided internally (as shown in FIG. 2) or externally to the computer device 200. Any of the software program modules in the program storage 212 and data from the data storage 214 are transferred to specific memory locations (e.g., RAM) as needed for execution by the processor 202.

As such, it is contemplated that some of the process steps discussed herein as software processes may be implemented within hardware, for example, as circuitry that cooperates with the processor 202 to perform various steps, such as those set forth below with respect to methods 300-700 of FIGS. 3-7. It is noted that the operating system (not shown) and optionally various application programs (not shown) are stored in the memory 210 to run specific tasks and enable user interaction.

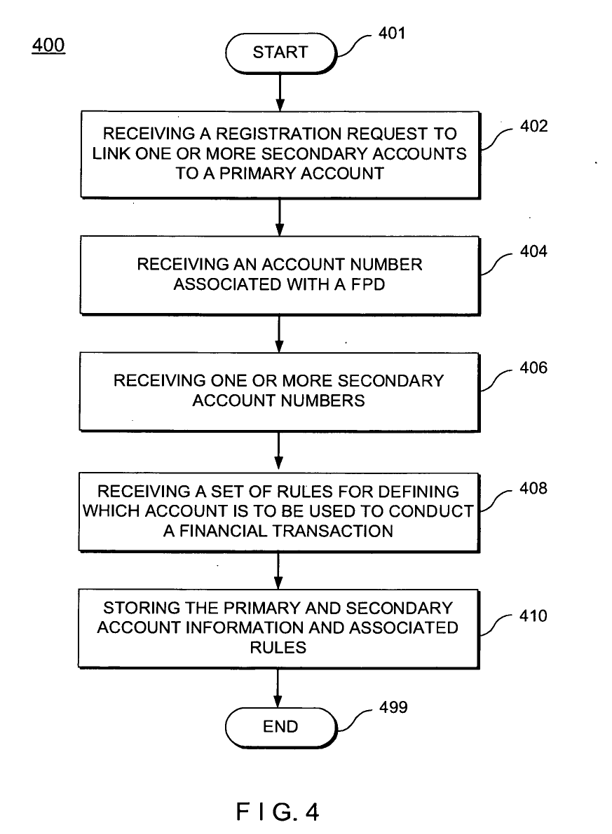

Referring now to FIG. 3, a flow diagram of a method 300 for linking a financial presentation device to multiple accounts for conducting a financial transaction in accordance with the present invention is illustratively shown. The method 300 begins at step 301 and proceeds to step 400, where the financial transaction processing facilitator 108 receives customer registration information for linking secondary accounts to a primary account associated with a financial presentation device (FPD), i.e., access device 112. The registration information includes account identifying information (e.g., account number) and a set of rules for using one of the registered accounts during a transaction. Details of the registration process are described below with respect to method 400 of FIG. 4.

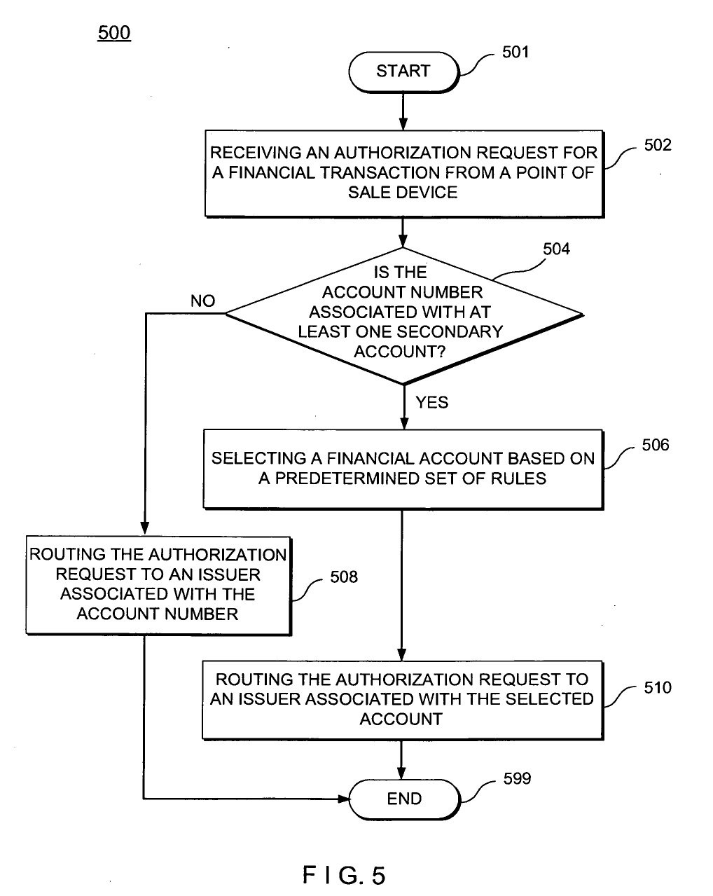

At step 500, the linked account processing module 220 receives an authorization request for a financial transaction that was originated at a merchant 106. The module 220 then selects an account to be used for a financial transaction and routes the authorization request to an issuer 102 associated with the selected account. The financial account that is selected is based on a set of predetermined rules which may be provided by the customer during the registration process or provided by account issuers based on the type of secondary accounts being linked. Details of selecting the appropriate issuer 102 for conducting a financial transaction are described below with respect to method 500 of FIG. 5.

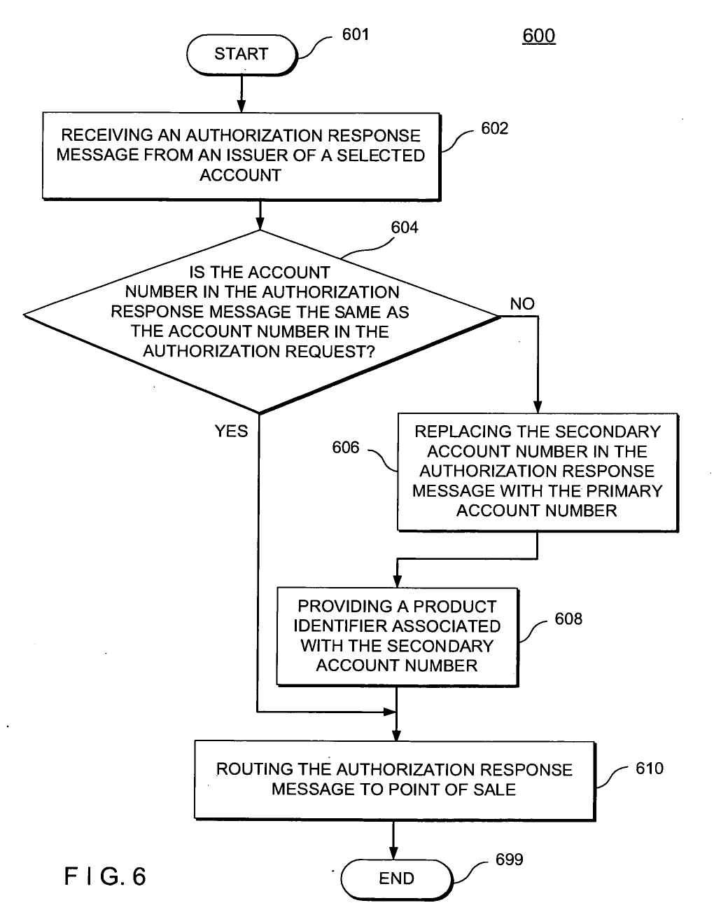

Once the issuer processes the authorization request, the issuer returns an authorization response to the processing facilitator 108. At step 600, the linked account processing module 220 routes the authorization response message from the issuer to the point of sale, e.g., the merchant 106, typically through an acquirer 104. The authorization response message is a communication from the issuer that tells the merchant that the issuer has either accepted or declined the transaction with the cardholding customer. Details of processing and routing of the authorization response message from issuer 102 are described below with respect to method 600 of FIG. 6.

At step 700, the linked account processing module 220 routes the clearing data received from the point of sale 106 to the selected issuer 102. Details of processing and routing the clearing data to issuer 102 are described below with respect to method 700 of FIG. 7.

Referring now to FIG. 4, the flow diagram illustrates a method 400 for processing a customer registration request to link one or more secondary accounts with a primary account. In this manner, the cardholder 110 can use a single access device 112 to access any one of the linked accounts to conduct a financial transaction at a point of sale. The customer is initially required to register a primary account and at least one secondary account. The customer can update the registration information to include additional access devices, delete old access devices and/or make other changes as required.

The method 400 starts at step 401, where a cardholder 110 of an access device 112 sends registration information to the financial transaction processing facilitator 108, illustratively, by accessing a registration webpage from the website of the processing facilitator 108 or at the website of the issuer 102 of the access device 112.

At step 402, the linked account processing module 220 receives a registration request to link one or more secondary accounts to a primary account. The registration request can be sent directly from the cardholder 110 at the processing facilitator's website or forwarded to the processing facilitator from an issuer 102 of the access device 112 being registered.

At step 404, the processing module 220 receives a unique access device identifier, preferably, the account number associated with the access device 112. The issuer can be typically identified by the initial few digits of the account number. Otherwise, the issuer name and routing information, if appropriate, are also requested and received by the processing module 220. This account number is defined as the primary account number associated with the access device. For example, if the access device 112 is a credit card, then the credit card number is provided by the cardholder 110. Alternatively, if the access device is a FSA account, then the FSA account number is provided by the cardholder 110. In yet another embodiment, the primary account can be a phone number of a mobile telephone or a virtual account number associated with another access device, such as a device having a unique RFID tag, and the like.

At step 406, the processing module 220 receives one or more secondary account numbers sent by the cardholder 110. The secondary account numbers can be associated with additional credit cards, debit cards, an FSA account, an HSA account, telephone service account or any other type of account that can be used to conduct financial transactions. The account numbers and the associated information are stored in the customer account identifiers database 232, which is a part of the linked account database 230.

At step 408, the processing module 220 receives a set of rules for defining which account is to be used to conduct a financial transaction from the cardholder. For each account number that is registered, the cardholder 110 provides one or more rules that define when the account should be used to conduct the transaction. The rules allow a customer to define transaction parameters or criteria, such as monetary amount of the transaction, the types of goods or services being purchased in the transaction, and/or a date range for using a particular account. The transaction criteria are used for selecting a particular account among the multiple accounts that are linked to the access device 112. Alternatively, the rules are automatically provided from pre-stored rules provided by the issuers for specific types of accounts being linked. The rules are stored in the customer rules database 234, which is a part of the linked account database 230.

The types of goods or services being purchased are typically categorized based on Merchant Category Codes (MCC). The MCCs are numeric values that are instituted by the International Organization for Standardization (ISO) to define a particular merchant or classification of merchants. A person of ordinary skill in the art will understand that most service orientated businesses, such as travel services, have a unique MCC. Conversely, sellers of goods generally have a common or shared MCC value based on the category or industry of the goods. For example, each national airline carrier or car rental company has its own unique MCC. However, companies that provide, for example, office supplies and printing products are all grouped under a single MCC. In any case, and as described below with respect to FIG. 5, the MCC that is provided by the merchant 106 in an authorization request message can be used to determine which of the financial accounts of the cardholder is to be used to conduct the financial transaction.

At step 410, the linked account processing module 220 stores the account information and associated rules i.e., “registration information” in the linked account database 230. The method 300 then proceeds to step 399, where the registration process ends, and the consumer or cardholder 110 is now able to conduct financial transactions using a single access device 112 linked to multiple accounts.

Referring to FIG. 1, the access device 112 is illustratively shown being used with a merchant 106 to conduct a transaction for goods and/or services. The authorization request, illustratively labeled X01 is sent to the acquirer 104, which forwards the authorization request X01 to the processing facilitator 108. The linked account processing module 220 performs method 500 described below with respect to FIG. 5, and routes the authorization request to the selected issuer, e.g., issuer 102₁ or 102₂ or issuer 102_{P}.

In particular, when an authorization request for the financial transaction is forwarded to the network of the financial transaction processing facilitator 108, the processing module 220 performs an account lookup to determine whether the account provided in the authorization request is to be used to conduct the transaction. Based on the rules established by the cardholder 110 (or the merchant or primary card issuer), when a secondary account is selected to conduct the transaction, the processing module 220 either retains or replaces the account number in the authorization request with the account number corresponding to the conditions set forth in the predetermined set of rules. If the authorization request is not modified, then it is routed to the issuer associated with the primary account. If however, the authorization request is modified, then it is routed to the issuer associated with the selected account (which may or may not be the issuer of the actual access device being used to conduct the transaction). If a secondary account is selected, the transaction will be processed as if the cardholder 110 presented the actual credit card (or other finance presentation device) associated with that secondary account at the POS 106. The selected issuer 102 then sends an authorization response message to the POS to either authorize or decline the transaction with the cardholder 110 of the access device 112. The cardholder receipt at the POS 106 identifies the access device, the card (i.e., access device) of record, and a product ID to denote the type of account accessed.

Referring now to FIG. 5, a flow diagram of a method 500 for routing an authorization request while conducting the financial transaction from a point-of-sale (POS) 106 to an issuer 102 is shown. The method 500 starts at step 501, where a cardholder 110 of a registered access device 112 conducts a transaction for goods and/or services with a merchant 106 or other point of sale using the registered access device 112. The transaction for the goods and/or services is conducted in a well known manner, where the merchant 106, for example, swipes the access device (e.g., credit card) through the magnetic card reader which sends an authorization request to the processing facilitator 108 through an acquirer 104 for routing to the issuer for authorization of the transaction.

At step 502, the linked account processing module 220 receives the authorization request for the financial transaction from the point of sale device 106. In particular, the authorization request from the merchant or other point of sale device 106 is transmitted to the acquirer 104, which subsequently routes the authorization request to the processing facilitator 108.

At step 504, the processing module 220 determines whether the account number of the access device 112 contained in the authorization request is associated with at least one secondary account. Referring to FIGS. 1 and 2, the linked account processing module 220 accesses the linked account database 230 to determine if the account number associated with the access device 112 being used to conduct the transaction is linked to multiple financial accounts.

If so, then the method 500 proceeds to step 506. Otherwise, the method 500 proceeds to step 508.

At step 506, a financial account (e.g., either the primary or a secondary account) is selected based on the predetermined rules stored in the account database 230. Recall that the cardholder 110 provides concise rules for selecting a particular account to be used for conducting the transaction during the registration process described above with respect to FIG. 4. It is noted that the merchant 106 and/or issuer 102 can also provide rules that should be followed to conduct a transaction. These rules include the type or goods and/or services being purchased during the transaction, monetary amounts of the transaction, date of the transaction, among other rules that are provided by the customer, merchant and/or issuer of the access device. In one embodiment, the processing module 220 compares the MCC value of the merchant in the authorization request to the MCC values assigned in the predetermined rules.

Alternatively, the processing module 220 compares the date range or total dollar amount of the transaction to any date range or dollar amounts prescribed in the predetermined set of rules provided by the customer, issuer or merchant. If the MCC value or other criteria for the transaction match at least one of the predetermined rules associated with one of the accounts, then that account is selected.

For example, a cardholder 110 may have registered a VISA credit card issued by Bank of America (BoA) as a primary access device, a VISA credit card issued by Chase as a first secondary account, and a FSA account as another secondary account. The predetermined rules can illustratively include conditions that all transactions for medical related goods and services are to be conducted using the FSA account, all travel and restaurant services are to be conducted using the Chase secondary account, and all other transactions are to be conducted using the primary account associated with the BoA credit card.

If at step 506, for example, the transaction being conducted is for payment of a dinner bill at a restaurant as determined by the MCC contained in the authorization request, then the secondary account associated with the Chase credit card is selected to conduct the transaction based on the aforementioned illustrative rules. In one embodiment, the processing module 220 modifies the authorization request by replacing the account number of the access device used to conduct the transaction with the account number of the selected secondary account. If, however, the predetermined rules direct that the primary account number of the access device 112 currently being presented at the POS 106 is to be used to conduct the transaction, then the account number in the authorization request remains the same, i.e., no modification to the account number occurs.

At step 510, the authorization request (containing either the original account number or a modified account number) is routed to the issuer of the selected account number. Continuing with the example above, the authorization request would be modified to change the account number of the BoA issuer to the account number of Chase. The method 500 ends at step 599.

Alternatively, if at step 504 it is determined that the account number associated with the access device 112 used to conduct the transaction is not linked with any other secondary accounts, the method 500 proceeds to step 508. At step 508, the authorization request is routed to the issuer 102 of the access device 112 used to conduct the present transaction. Accordingly, the authorization request is not modified to change the account number prior to routing the request to the issuer. At step 599, the authorization request is sent to the selected issuer and the method 500 ends.

Referring to FIG. 6, a flow diagram of a method 600 for routing the authorization response message from the issuer to the POS (e.g., merchant) 106 is shown. The method 600 begins at step 601, where the issuer 102 that received the authorization request to authorize the transaction verifies and authenticates the financial presentation device 112 of the cardholder 110 in a well-known manner. Referring to FIG. 1, the selected issuer generates the authorization response message, illustratively labeled X10, and sends it to the financial transaction processing facilitator 108 for further processing and routing to the point of sale, e.g., the merchant 106.

Referring again to FIG. 6, at step 602, the processing facilitator 108 receives the authorization response message (e.g., message X10 of FIG. 1) from the issuer of the selected account. At step 604, a determination is made whether the account number in the authorization response message is the same as the account number in the authorization request.

Specifically, the computer device 200 includes an authorization and authentication (AA) module (not shown) that processes and pairs corresponding authorization request and response messages. The pairing of corresponding authorization request and response messages enables the processing module 220 to compare the account number information provided in each paired message. In one embodiment, information from the authorization request is copied and stored in memory (e.g., a database or temporary table) of the computer device 200 prior to being routed to the appropriate issuer 102. The authorization response message from the issuer 102 is subsequently paired with the corresponding authorization request by the AA module, and the information or relevant portions thereof is copied and stored in memory prior to being routed to the corresponding merchant 106. Once the authorization request and corresponding response message information has been paired and stored in memory, the processing module 220 compares the account number in the authorization response message to the account number in the authorization request.

It is noted that the pairing of the authorization request and response messages can be facilitated by various techniques. In one embodiment, each paired authorization request and authorization response message is assigned sequential values. For example, the authorization request and response messages can be nearly identical digital words except that, for example, the last two bits or least significant bit (LSB) or most significant bit (MSB) differs therebetween (e.g., authorization request having LSB=0 and authorization response having LSB=1). Referring to FIG. 1, the authorization request message is illustratively shown having a unique identifier value of X, with the last two bits being assigned the value 01. Similarly, the authorization response message also has a unique identifier value of X, but the last two bits are assigned the value 10.

In an alternative embodiment, the pairing process can be accomplished by modifying the authorization response message at the issuer to include the unique identifier of the originating authorization request message in one of its fields. The AA module uses the identifier of the originating authorization request message to pair the response message therewith. A person of ordinary skill in the art will appreciate that other techniques can be used to pair the authorization request and response messages. In any embodiment, once the processing facilitator 108 receives and pairs the authorization response message from the issuer with the corresponding authorization request, the linked account processing module 220 compares the account information in the authorization response message to the account information from the authorization request message.

At step 604, if the account number in the authorization response message is not the same as the account number in the authorization request, then the method 600 proceeds to step 606, where the authorization response message is modified. In particular, at step 606, the processing module 220 replaces the account number associated with the selected issuer with the account number associated with the access device (e.g., primary account number) used to initiate the financial transaction. The method 600 then proceeds to step 608.

At step 608, the processing module includes a product identifier associate with the secondary account. The product identifier defines the type of secondary account that was accessed to conduct the transaction. In one embodiment, the product identifier is a byte or word that denotes whether the secondary account is a credit card, a debit card, an FSA, an HSA and the like. The product identifier is used during clearing and settlement of the transaction as a determinant of interchange fees that are paid to the issuers.

At step 610, the authorization response message is routed to the point of sale, e.g., merchant 106. At step 699, the method 600 ends.

If, however, at step 604 the account number in the authorization response message is the same as the account number in the authorization request, then the method 600 proceeds to step 610, where the authorization response message is routed to the point of sale, e.g., merchant 106. At step 699, the method 600 ends.

Accordingly, the system and methods of the present invention enable a cardholder to seamlessly conduct a financial transaction at a point of sale using a single access device that is linked to multiple accounts associated with different issuers. From the perspective of the merchant 106, the merchant is not required to know which linked account (and issuer) is being utilized to conduct the transaction. Rather, the authorization response message sent by the selected issuer is the only information required for the merchant in making a determination to accept or decline the transaction.

From the perspective of the cardholder 110, the cardholder is relieved of having to carry multiple access devices and of having to select a particular access device 112 to conduct a particular transaction. The cardholder only needs to know if the merchant is accepting or declining the transaction. From the perspective of the issuer 102, the issuer does not know which access device was actually used by the cardholder to conduct the transaction. Rather, the processing module 220 of the present invention modifies the authorization request with the selected account number and routes the modified authorization request to the appropriate issuer. Accordingly, the cardholder, merchant and issuer can conduct a financial transaction seamlessly and in a normal way, without any additional processing steps or any modification to the hardware.

Once the transaction has been authorized, clearing and settlement of the transaction is facilitated by the processing facilitator 108. Transaction clearing is the process of exchanging financial transaction details between an acquirer 104 and an issuer 102 to facilitate posting of a cardholder's account and reconciliation of a customer's settlement position. Settlement is the actual crediting and debiting of accounts.

Transaction clearing can be provided using single-message processing or dual-message processing. A single-message system (SMS) provides a method for contemporaneously authorizing and clearing a transaction using a single message, which carries all information needed to post a transaction to an account and to enable clearing and settlement. Accordingly, for the single-message system (SMS), the authorization request and response messages include the necessary clearing and settlement information to further support and deliver online authorization, clearing, and settlement services for each individual transaction.

The transaction clearing processing system used by the issuers is usually dependent on their infrastructure capabilities. However, the processing facilitator 108 can accommodate either types of transaction clearing process.

For those financial transactions that use the single-message processing system, no additional clearing steps are required to clear the transaction. Rather, the authorization request and response messages include all the necessary information to clear the transaction.

However, where the dual-message processing system is being utilized, the financial clearing of the transaction is completed after the actual transaction has taken place, that is, after the transaction authorization process is completed. Thus, additional clearing steps are required for the dual-message processing once the transaction authorization process is completed.

The merchant sends clearing data (i.e., data elements present at the time of authorization) back to the issuer 102 that conducted (i.e., authorized) the transaction during the course of the business day. The clearing data is sent in the form of a batch file 140 which includes the merchant's transaction information for the business day. Typically, the clearing batch file 140 is sent to the clearing house via the processing facilitator 108 at low-peak transaction periods (i.e., late in the evening) by the merchant 106.

Referring to FIG. 7, a flow diagram of a method 700 for providing transaction clearing utilizing a dual-message processing system is shown. The processing facilitator 108 facilitates the transfer of clearing data as provided by method 700. The method 700 starts at step 701, where the merchant 106 sends clearing data in the form of a batch file 140 to the acquirer 104, which forwards the clearing data 140 to the processing facilitator 108. At step 702, a clearing data module (not shown in FIG. 1) receives the clearing data from the acquirer 104 associated with the point of sale (e.g., the merchant) 106. The clearing data file 140 is parsed and stored so that each financial transaction associated with the merchant can be separately processed for clearing by the linked account processing module 220.

At step 704, the linked account processing module 220 determines, for each transaction, whether the account number provided in the clearing data is associated with at least one secondary account. At step 704, if the account number in the clearing data is associated with at least one secondary account, then the method 700 proceeds to step 706. At step 706, in one embodiment, an account number is selected based on the predetermined set of rules. For example, if the predetermined set of rules direct that the primary account be used for the transaction, then the clearing data associated with a transaction is modified to include the primary account if the clearing data for a particular transaction does not include the primary account number. Similarly, if the predetermined set of rules direct that a secondary account be used for the transaction, the clearing data is modified to include the selected secondary account. Instead of actually including the actual account number used in the clearing data, a pointer can be provided in the data which will be used by the clearing system to retrieve the account number used during authorization.

In an alternative embodiment, at step 706, an account number can be selected based on the authorization request and/or response messages. The processing module 220 compares the account number used to conduct the financial transaction that is included with the clearing data to the account number provided in either modified the authorization request or the unmodified response message stored in memory as described above with respect to FIG. 5.

For example, if the authorization request was previously modified to change the account number to a selected account number based on the predetermined set of rules, then processing module 220 retrieves the modified account number from the authorization (or response) message to similarly modify the clearing data to include the selected secondary account.

At step 710, the modified clearing data is subsequently routed to the issuer associated with the selected secondary account. A person of ordinary skill in the art will appreciate that the clearing data for each transaction can be routed individually or preferably, as batch files to the appropriate issuer associated with the selected account. The method then proceeds to step 799, where the method 700 ends.

If, however, at step 704 it is determined that the account number provided in the clearing data is not associated with at least one secondary account, then the method 700 proceeds to step 708. At step 708, the clearing data is not modified, and is routed in its original form to an issuer 106 associated with the account number of the access device 112. The method 700 then proceeds to step 799, where the method 700 ends.

Accordingly, the present invention overcomes the deficiencies of the prior art by enabling a consumer to access multiple accounts from a single financial presentation device while conducting a purchase transaction of goods and/or services from a merchant or other point of sale. Advantageously, the consumer does not have to carry multiple financial presentation devices or account access devices with them. Rather, the consumer can carry a single account access device, which is less cumbersome to carry, and reduces the risks of misplacing or losing multiple financial presentation devices at one time.

The foregoing specific embodiments represent just some of the ways of practicing the present invention. Many other embodiments are possible within the spirit of the invention. Accordingly, the scope of the invention is not limited to the foregoing specification, but instead is given by the appended claims along with their full range of equivalents.

What is claimed is:

1. A system for conducting a financial transaction with a financial presentation device (FPD) of a holder which is presentable to providers of goods or services, the system comprising:
a processor; and
a linked account processing module executable by the processor, the processing module receiving an authorization request for a financial transaction, the authorization request being initiated by a merchant computer at a point of sale of a merchant in response to presentation of the FPD at the point of sale, the processing module further determining whether the FPD is associated with multiple financial accounts, and if so,
selecting one account among the multiple associated financial accounts and routing the authorization request to an issuer of the selected financial account.

2. The system of claim 1, wherein if it is determined that the FPD is associated with multiple financial accounts, the linked account processing module modifies the authorization request to include information for routing the authorization request to the issuer of the selected financial account.

3. The system of claim 2, wherein the linked account processing module replaces a financial account identifier contained in the authorization request with a financial account identifier associated with the selected financial account prior to routing the authorization request.

4. The system of claim 3, wherein the linked account processing module:
receives an authorization response from the issuer of the selected financial account; and
replaces a financial account identifier contained in the authorization response with the financial account identifier contained in the received authorization request prior to routing the authorization response to the merchant computer.

5. The system of claim 1, wherein the linked account processing module:
receives clearing data regarding the financial transaction from an acquirer associated with the point of sale;
determines the issuer associated with the selected financial account; and
routes the clearing data to the determined issuer.

6. The system of claim 5, wherein the linked account processing module replaces a financial account identifier contained in the clearing data with the financial account identifier associated with the selected financial account prior to routing the clearing data to the determined issuer.

7. The system of claim 1, wherein each account is associated with a credit card, debit card, telephone number, email address, or a virtual account.

8. The system of claim 1, further comprising a memory for storing a set of predetermined rules for determining which of the financial accounts is to be used to conduct a financial transaction, wherein the linked account processing module selects one account among the multiple financial accounts based on the stored predetermined set of rules.

9. The system of claim 8, wherein the stored set of predetermined rules contains criteria including at least one of monetary amount of the financial transaction, and type of product or service being purchased during the financial transaction.

10. A system for conducting a financial transaction with a financial presentation device (FPD) of a holder which is presentable to providers of goods or services, the system comprising:
a memory for storing, for each FPD, account information of multiple financial accounts and a set of predetermined rules for determining which of the financial accounts is to be used to conduct a financial transaction;
a processor coupled to the memory; and
a linked account processing module stored in the memory and executable by the processor, the processing module receiving an authorization request for the financial transaction, the authorization request being initiated by a merchant computer at a point of sale of a merchant in response to presentation of the FPD at the point of sale, the processing module further determining whether the FPD is associated with multiple financial accounts based on the stored account information, and if so,
selecting one account among the multiple financial accounts based on the stored predetermined set of rules and routing the authorization request to an issuer of the selected financial account.

11. The system of claim 10, wherein if it is determined that the FPD is associated with multiple financial accounts, the linked account processing module modifies the authorization request to include information for routing the authorization request to the issuer of the selected financial account.

12. The system of claim 11, wherein the linked account processing module replaces a financial account identifier contained in the authorization request with a financial account identifier associated with the selected financial account prior to routing the authorization request.

13. The system of claim 12, wherein the linked account processing module:
receives an authorization response from the issuer of the selected financial account; and
replaces a financial account identifier contained in the authorization response with the financial account identifier contained in the received authorization request prior to routing the authorization response to the merchant computer.

14. The system of claim 10, wherein the linked account processing module:
receives clearing data regarding the financial transaction from an acquirer associated with the point of sale;
determines the issuer associated with the selected financial account; and
routes the clearing data to the determined issuer.

15. The system of claim 14, wherein the linked account processing module replaces a financial account identifier contained in the clearing data with the financial account identifier associated with the selected financial account prior to routing the clearing data to the determined issuer.

16. The system of claim 10, wherein each account is associated with a credit card, debit card, telephone number, email address, or a virtual account.

17. The system of claim 10, wherein the set of predetermined rules stored in the memory contains account selection criteria based on at least one of monetary amount of the financial transaction, and type of product or service being purchased during the financial transaction.

18. A method for conducting a financial transaction with a financial presentation device of a holder which is presentable to providers of goods or services comprising the steps of:
storing, in a memory of a transaction facilitator computer, a set of predetermined rules for determining which of the financial accounts is to be used to conduct a financial transaction;
receiving, by the linked account processing module being executed in the transaction facilitator computer, an authorization request for a financial transaction, the authorization request being initiated by a merchant computer at a point of sale in response to presentation of the financial presentation device at the point of sale;
determining, by the linked account processing module, whether the financial presentation device is associated with multiple financial accounts;
if it is determined that the financial presentation device is associated with multiple financial accounts, then:
selecting, by the linked account processing module, one account among a plurality of financial accounts based on the stored predetermined set of rules; and
routing the authorization request to an issuer of the selected financial account.

19. The method of claim 18, wherein if it is determined that the FPD is associated with multiple financial accounts, the method further comprises modifying, by the linked account processing module, the authorization request to include information for routing the authorization request to the issuer of the selected financial account.

20. The method of claim 19, further comprising replacing, by the linked account processing module, a financial account identifier contained in the authorization request with a financial account identifier associated with the selected financial account prior to routing the authorization request.

21. The method of claim 20, further comprising:
receiving, by the linked account processing module, an authorization response from the issuer of the selected financial account; and
replacing, by the linked account processing module, a financial account identifier contained in the authorization response with the financial account identifier contained in the received authorization request prior to routing the authorization response to the merchant computer.

22. The method of claim 18, further comprising:
receiving, by the linked account processing module, clearing data regarding the financial transaction from an acquirer associated with the point of sale;
determining, by the linked account processing module, the issuer associated with the selected financial account; and
routing the clearing data to the determined issuer.

23. The method of claim 22, further comprising replacing, by the linked account processing module, a financial account identifier contained in the clearing data with the financial account identifier associated with the selected financial account prior to routing the clearing data to the determined issuer.

24. The method of claim 18, wherein each account is associated with a credit card, debit card, telephone number, email address, or a virtual account.

25. The method of claim 18, wherein the set of predetermined rules stored in the memory contains account selection criteria based on at least one of monetary amount of the financial transaction, and type of product or service being purchased during the financial transaction.
